(19) United States
(12) Patent Application Publication
(10) Pub. No.: US 2025/0196422 A1
(43) Pub. Date: Jun. 19, 2025

(54) THROTTLE GROOVES AND CONTROL LOOP/METHOD TO ACHIEVE AN OPTIMIZED PRESSURE CONSTANT BACKFLUSH PROCEDURE OF THE SCREEN CAVITY OF A SCREEN CHANGER DURING BACKFLUSH

(71) Applicant: NORDSON CORPORATION, WESTLAKE, OH (US)

(72) Inventors: Stefan WOESTMANN, Sassenberg (DE); Markus WALBERSMANN, Schöppingen (DE); Robert MIDDLER, Havixbeck (DE)

(73) Assignee: NORDSON CORPORATION, WESTLAKE, OH (US)

(21) Appl. No.: 18/844,420

(22) PCT Filed: Mar. 20, 2023
(86) PCT No.: PCT/IB2023/052726

§ 371 Date: Sep. 6, 2024

(30) Foreign Application Priority Data
Mar. 18, 2022 (DE) 10 2022 106 334.8

(51) Int. Cl. B29C 48/693; B29C 48/255; B29C 48/691

(52) U.S. Cl. CPC B29C 48/693; B29C 48/2554; B29C 48/6912

(57) ABSTRACT

A filtering device for filtering a fluid, in particular a liquefied plastic, includes a housing having a receptacle for receiving a screen carrier and having a fluid inlet channel and a fluid outlet channel, a screen carrier movably received along a longitudinal axis inside the receptacle and having a screen carrier inlet, a screen carrier outlet and a cavity for receiving a filter element, wherein the cavity is in fluid communication with the screen carrier inlet and the screen carrier outlet, and the screen carrier can be moved from a screen replacement position via a venting position area into a filtering position. The screen carrier has a throttle recess which is arranged adjacent to the screen carrier outlet and is in fluid communication with the cavity, and which opens a variable flow cross-section between the cavity and the fluid outlet channel.

### CROSS-REFERENCE TO RELATED APPLICATIONS

This application is a National Stage Application of International Application No. PCT/PCTIB2023052726, filed Mar. 20, 2023 designating the U.S., which claims priority to German Patent Application No. 10 2022 106 334.8, filed Mar. 18, 2022, all of which are incorporated herein by reference in their entirety.

### FIELD OF THE DISCLOSURE

The disclosure relates to a filtering device for filtering a fluid, in particular a liquefied plastic, comprising a housing having a receptacle for receiving a screen carrier and having a fluid inlet channel and a fluid outlet channel, a screen carrier movably received along a longitudinal axis inside the receptacle and having a screen carrier inlet, a screen carrier outlet and a cavity for receiving a filter element, wherein the cavity is in fluid communication with the screen carrier inlet and the screen carrier outlet, and wherein the screen carrier can be moved from a screen replacement position via a venting position area into a filtering position.

### BACKGROUND OF THE DISCLOSURE

Filtering devices are used in plastics processing machines, for example, when the purity of the plastic being processing must meet tough requirements. They are typically arranged between an extruder, which melts and conveys the plastic, and an applicator. Such filtering devices for filtering a fluid, in particular a liquefied plastic, and methods therefor are known from the prior art. DE 10 2007 057 861 A1, for example, describes such a filtering device comprising a screen carrier in which a filter element, also referred to as a screen, is arranged.

Such filter elements must typically be replaced or cleaned when they have been in operation for some time. To replace the filter element, the screen carrier is moved from the filtering position, also known as the production position, into a screen replacement position, so called, in which the filter element can be accessed and replaced.

Once the filter element has been replaced, it must be brought back into the production process. The poses the challenge that the interior spaces of the screen carrier, referred to as cavities, are typically filled with air after replacement of the screen and that it is essential to prevent air from being introduced into the stream of plastic fluid. After replacement of the screen, the screen carrier is firstly moved for that reason into a venting position area in which liquefied plastic flows into the screen cavity and displaces the air contained therein to the outside via venting channels.

Once the cavity has been completely filled or vented, the liquefied plastic must be set in motion again in order to start the filtration process. This is due to the fact that the plastic melt has a certain inertia, with the consequence that undesirable pressure fluctuations can occur in the system as a whole when the melt is accelerated. Accelerating the melt after it has come to a standstill in such a way that the overall system pressure stays within narrowly definable limits has therefore proved challenging.

This aspect also plays a role in the backflushing of filter elements, in which the latter are backflushed in the opposite direction to the filtering direction using plastic melt, in order to clean them. The plastic used for backflushing is taken from the plastic fluid stream to be filtered. If the stream of plastic fluid is backflushing too fast, this can likewise have negative impacts on the system pressure. When using spinning nozzles, for example, such fluctuations in pressure can have an adverse effect on the spinning process. The product quality can suffer, or the spun threads can even break.

A method for controlling a plastics processing system is known from the prior art, for example from DE 10 2006 019 445 A1, which proposes that pressure changes be equalized by adjusting the feed rate of a conveying device. The disadvantage of the prior art described above is the delay in regulation between the drop in system pressure caused by filling the cavity, and the adjustment of the pump output. Pressure fluctuations cannot be ruled out with sufficient reliability as a result.

This way of controlling the pump output according to the screen replacement operation is also a factor that increases the system complexity, thus increasing the production costs and the servicing work required for such a machine.

### SUMMARY OF THE DISCLOSURE

Given this background, an aspect of the disclosure is to develop a device and a method of the kind initially specified in such a way that the disadvantages identified in the prior art are eliminated as far as possible. A specific aspect of the disclosure is to specify a device and a method in which the overall system pressure is kept largely constant during a screen replacement operation or during backflushing of a filter element, and in which the complexity of the system is reduced on the whole.

According to the disclosure, this aspect is achieved, in a device of the kind initially specified, by the screen carrier having a throttle recess which is arranged adjacent to the screen carrier outlet and is in fluid communication with the cavity, and which opens a variable flow cross-section between the cavity and the fluid outlet channel, depending on the position of the throttle recess relative to the fluid outlet channel (claim 1).

The disclosure makes use of the discovery that arranging a throttle recess adjacent to the screen carrier outlet allows particularly fine adjustment of a free flow cross-section between the fluid outlet channel and the cavity. Once the cavity has been fully vented via the throttle recess, the cavity can thus be connected to the fluid outlet channel in such a way that the melt is gently accelerated out of the cavity in the direction of the fluid outlet channel. In other words, the melt received in the fluid inlet channel and in the cavity can thus be controlled and slowly set in motion in such a way that the overall system pressure is almost unaffected by the acceleration operation or at least is kept within tolerable limits.

According to an aspect, the screen carrier can be moved out of the venting position area via an acceleration position area into the filtering position, wherein the throttle recess opens a variable flow cross-section between the cavity and the fluid outlet channel, depending on the position of the throttle recess relative to the fluid outlet channel in the acceleration position area. The acceleration position area may be separated from the venting position area, so the melt does not accelerate until after it has passed through the venting position area, in particular, i.e. until after the cavity has been fully vented.

Due to the acceleration position area according to the disclosure, a flow channel may be formed by a recess or a groove, is provided for the first time, and which helps and is used to set the melt in motion again after a functional pause, in particular a screen replacement, i.e. to accelerate the overall flow, in such a way that this is may be carried out so gently that no major pressure fluctuations and/or major turbulence occur in the filtering device and may be in the system as a whole, and/or that no mixing of melt and gas occurs (also referred to occasionally as foaming).

The disclosure is developed by the throttle recess extending along the longitudinal axis, starting from the screen carrier outlet and viewed from the screen replacement position in the direction of the fluid outlet channel. The variable flow cross-section between the cavity and the fluid outlet channel is thus opened and/or adjusted by moving the throttle recess in the direction of the fluid outlet channel by moving the screen carrier. In other words, by changing the position of the screen carrier along the longitudinal axis, it is possible to influence the flow cross-section between the cavity and the fluid outlet channel as desired.

According to an aspect, the throttle recess has a cross-section that varies in the direction of the longitudinal axis. The cross-section of the throttle recess may taper in the direction of the longitudinal axis, starting from the screen carrier outlet. Any movement of the screen carrier and thus any movement of the throttle recess in the direction of the fluid outlet channel thus results in only a very small flow cross-section being opened initially between the cavity and the fluid outlet channel, and in the flow cross-section increasing disproportionately as the screen carrier is further advanced. In this way, the system pressure can be advantageously influenced and the melt can be advantageously accelerated.

The cross-section of the throttle recess may taper linearly in the direction of the longitudinal axis, starting from the screen carrier outlet. According to an aspect, the cross-section has a basic form that is wedge-shaped or notch-shaped. This allows particularly sensitive adjustment of the flow cross-section.

According to an aspect, the fluid inlet channel and the fluid outlet channel are arranged in the housing in such a way that when the screen carrier moves from the screen replacement position via the venting position area and the acceleration position area in the direction of the filtering position, the cavity in the venting position area is initially, in particular exclusively, in fluid communication with the fluid inlet channel and when the screen carrier moves further in the direction of the filtering position, the cavity in the acceleration position area is additionally put in fluid communication with the fluid outlet channel via the throttle recess. This results in the cavity being filled particularly gently in terms of the overall system pressure. By connecting the fluid inlet channel to the cavity, the fluid inlet is firstly vented. In this position, there is no connection as yet to the fluid outlet channel. It is not until the screen carrier has been moved further in the direction of the filtering position via the throttle recess that a very small flow cross-section is initially opened to the fluid outlet channel, with the result, as described above, that the melt in the cavity is accelerated particularly gently, which as noted above is particularly conducive to a constant overall system pressure. Moreover, if there were already a connection to the outlet channel when the cavity is being vented, air bubbles could be forced through into the production process, which is undesirable.

According to an aspect, the screen carrier adjacent to the screen carrier inlet has an inlet throttle recess which is in fluid communication with the cavity, and which opens a variable flow cross-section between the cavity and the fluid inlet channel, depending on the position of the inlet throttle recess relative to the fluid inlet channel in the venting position area. In this way, melt is fed particularly gently and sensitively to the cavity, even when the cavity is vented by means of an inlet throttle recess, whereby pressure fluctuations in relation to the overall system pressure are avoided here also, as far as possible.

The inlet throttle recess may extend along the longitudinal axis, starting from the screen carrier inlet and viewed from the screen replacement position in the direction of the fluid inlet channel. This ensures that the cavity is connected to the fluid outlet channel firstly via the inlet throttle recess, which allows the cavity to be flooded in a particularly sensitive manner. The inlet throttle recess may have a cross-section that varies in the direction of the longitudinal axis. Designing the inlet throttle recess in this manner has proven to be advantageous for allowing the cavity to be filled particularly gently with regard to the overall system pressure.

The disclosure is developed by the screen carrier having at least one venting recess which puts the cavity in fluid communication with the surroundings, depending on the position of the venting recess relative to the housing. Such a venting recess is a proven technique for influencing the venting operation not only on the inlet side, i.e. in the region of the fluid inlet channel, but also in the outlet region. The venting recess may extend along the longitudinal axis. This means that the cross-section available for the discharge of air can be varied via the positioning of the screen carrier and thus the venting recess relative to the housing.

According to an aspect, the venting recess is a first venting recess, the screen carrier having a second venting recess which is in fluid communication with the cavity, wherein the second venting recess has a smaller longitudinal extension along the longitudinal axis than the first venting recess and is arranged in such a way that when screen carrier moves from the screen replacement position in the direction of the filtering position, the cavity is firstly vented via the first and the second venting recess, and when the screen carrier moves further in the direction of the filtering position, the cavity is vented only via the first venting recess. The screen carrier may have a third venting recess, wherein the third venting recess has a smaller longitudinal extension along the longitudinal axis than the second venting recess.

According to an aspect, the first venting recess is in fluid communication with a first subarea of the cavity, and/or the second venting recess is in fluid communication with a second subarea of the cavity and/or the third venting recess is in fluid communication with a third subarea of the cavity. This allows not only the venting of the cavity as a whole to be influenced, but also individual subareas of the cavity to be vented in a targeted manner.

When the screen carrier moves from the screen replacement position in the direction of the filtering position, the screen carrier in the venting position area is may be vented initially via all three venting recesses, although more than three, in particular four venting recesses may be provided. Initially, all and in particular all three venting recesses may be connected to the surroundings of the surroundings of the filtering device. Melt then exits typically from the shortest venting recess first. Then, after a delay of a few seconds, it also exists from the venting recess of medium length, after which it also exits from the next longest venting recess, and so on. Once the cavity has been fully vented via the respective venting recess, the connection of the respective venting recess to the surroundings is interrupted by successively advancing the screen carrier in the direction of the filtering position, initially the connection of the shortest venting recess to the surroundings, then the venting recess of medium length, and so on, until finally all the venting recesses are separated from the surroundings by them retracting into the housing.

According to an aspect, at least one or in particular all of the venting recesses are designed as a groove. During venting, the cavity is may be in fluid communication with the fluid inlet channel exclusively, but not with the fluid outlet channel. This allows step-by-step venting and reintroduction of the melt into the production process. According to an alternative aspect, at least one or in particular all of the venting recesses are designed as venting holes.

According to a development of the disclosure, the filtering device has a control unit which is configured and designed in such a way that after venting of the cavity it moves the screen carrier further by means of control signals in the direction of the filtering position such that the fluid outlet channel is initially put into exclusive fluid communication with the cavity by means of the throttle recess, and the screen carrier is moved in the direction of the filtering position in such a way that a fluid pressure in the fluid inlet channel and/or in the fluid outlet channel stays within a definable pressure range. By utilizing the throttle recess, the filtering device can thus be controlled in a particularly advantageous manner. For example, a specific maximum pressure drop can also be defined that specifies the feed speed of the screen carrier to some extent. If an excessive pressure drop is observed, for example, the feed speed of the screen carrier is reduced. On the other hand, the feed speed of the screen carrier can also be increased if a very low pressure drop that is lower than a defined threshold value is observed.

The screen carrier can be advanced continuously, for example, or also step by step, so that the response, for example of the system pressure, can be awaited and assessed. Such a control logic also has the advantage of being independent of material viscosities and throughputs.

According to a second aspect of the disclosure, the screen carrier is vented in the venting position area by feeding a fluid via the fluid outlet channel, and wherein the screen carrier has a throttle recess, in particular an acceleration groove, which is arranged adjacent to the screen carrier inlet and which is in fluid communication with the cavity, and which opens a variable flow cross-section between the cavity and the fluid inlet channel, depending on the position of the throttle recess relative to the fluid inlet channel (claim 13).

This alternative arrangement of the throttle recess takes account of the fact that, in some filtering devices, the screen carrier is vented via the fluid outlet channel and not, as described in the above aspects, via the fluid inlet channel. In this alternative configuration of the filtering device, accordingly, the throttle recess is also arranged adjacent to the screen carrier inlet. Moreover, the filtering device according to the second aspect makes use of the same advantages and aspects as the filtering device according to the first aspect of the disclosure, while taking into account the alternative functional principle and location of the throttle recess. Reference is made in this regard to the observations above, the content of which is incorporated here by reference.

According to a third aspect of the disclosure, and/or according to an advantageous development of the disclosure according to the first and/or second aspect, it is proposed that the housing has a backflush supply channel which is configured to feed backflush fluid to the filter element in a backflush position area from the clean side of the filter element to the dirt side, and a backflush channel which is configured to discharge the backflush fluid after backflushing, wherein the screen carrier can be moved into a backflush position area in which the backflush supply channel is at least partially in fluid communication with a clean side of the filter element, and the backflush channel is at least partially in fluid communication with the dirt side of the filter element, wherein the screen carrier has a backflush recess which is arranged between the backflush supply channel and the screen carrier outlet and is in fluid communication with the cavity, and which opens a variable flow cross-section between the backflush supply channel and the cavity, depending on the position of the backflush recess relative to the backflush supply channel in the backflush position area (claim 14).

This third aspect of the disclosure, and/or the advantageous development of the disclosure, makes uses of the discovery that, in the backflushing position, a connection to the backflush channel is opened with a large volume, in particular completely. The backflush volume is adjusted via the backflush recess between the backflush supply channel and the cavity, and thus in the region of the clean side of the filter element. To that extent, the backflush volume can be adjusted as desired in order to minimize the fluctuations in pressure within the system. Unlike the solutions known from the prior art, in which the volume of contaminated melt used for backflushing is adjusted, a particular advantage here is that larger dirt particles have no effect on the backflushing behavior, whereas in the case of devices known from the prior art, it has been observed, in particular, that dirt particles have to pass through a particular bottleneck and that this is occasionally clogged, with the result that backflushing becomes ineffective. Backflushing can be adjusted sensitively due to the backflush recess having a variable cross-section along the longitudinal axis. In other words, throttling is adjusted on the “clean” side. This prevents clogging. In the prior art, throttling is carried out on the dirt side, which entails the risk of clogging or results in a large opening and the inevitable pressure fluctuations associated with that.

The disclosure is developed by the backflush recess extending along the longitudinal axis, starting from the screen carrier outlet and viewed from the filtering position in the direction of the backflush supply channel. This configuration ensures that the volume of melt supplied can be finely adjusted by varying the flow cross-section between the backflush supply channel and the cavity. According to the disclosure, the backflush recess has a cross-section that varies in the direction of the longitudinal axis. The cross-section of the backflush recess may taper in the direction of the longitudinal axis, starting from the screen carrier outlet. According to an aspect, the cross-section of the backflush recess tapers linearly in the direction of the longitudinal axis, starting from the screen carrier outlet. The melt used for backflushing can thus be supplied in very precise doses, thus ensuring that the overall system pressure stays within definable limits. According to an aspect, the cross-section has a basic form that is wedge-shaped or notch-shaped. This basic form makes a further contribution towards precise dosing of the melt used for backflushing.

According to an aspect, the filtering device has a control unit which is configured and designed so that it changes the position of the screen carrier during backflushing of the screen carrier by means of control signals in such a way that the fluid pressure in the fluid inlet channel and/or in the fluid outlet channel stays within a definable pressure range during backflushing, such that a variable flow cross-section between the backflush supply channel and the cavity is opened by means of the backflush recess when the screen carrier is moved within the backflush position area.

The disclosure has been described above with reference to a filtering device. In a second aspect, the disclosure relates to a method for operating a filtering device, in particular a filtering device according to any one of the aspects above. In respect of the method, the disclosure achieves the aspect initially specified with the steps of: venting the cavity, moving the screen carrier further in the direction of the filtering position by means of control signals after venting the cavity, in such a way that the fluid outlet channel is initially put into exclusive fluid communication with the cavity by means of the throttle recess, and the screen carrier is moved in the direction of the filtering position in such a way that a fluid pressure in the fluid inlet channel and/or in the fluid outlet channel stays within a definable pressure range (claim 21).

The method member thus utilizes the same advantages and aspects as the filtering device according to the disclosure, and vice versa. Reference is made in this regard to the observations above, the content of which is incorporated here by reference. What the method according to the disclosure achieves, in summary, is that, after the cavity has been vented, the melt inside it can be accelerated very slowly and sensitively by establishing a connection to the fluid outlet channel by means of the throttle recess, thus ensuring that the fluid pressure in the fluid inlet channel or fluid outlet channel stays within a defined pressure range.

The method is developed, in particular for filtering devices with a backflush function, by the step of: moving the screen carrier in the direction of the backflush position area by means of control signals in such a way that the fluid pressure in the fluid inlet channel and/or in the fluid outlet channel stays within a definable pressure range, during backflushing, wherein a variable flow cross-section between the backflush supply channel and the cavity is opened by means of the backflush recess, wherein the backflush recess is arranged between the backflush supply channel and the screen carrier outlet and is in fluid communication with the cavity. This means that, even during backflushing, pressure fluctuations caused by backflushing are prevented, and that larger dirt particles have no effect on the backflushing behavior.

Further features and advantages of the disclosure ensue from the attached claims and the following description, in which aspects are described in more detail with reference to schematic drawings.

### BRIEF DESCRIPTION OF THE DRAWINGS

In the Figures,

FIG. 1 shows a first aspect of a filtering device according to the disclosure in a cross-sectional side view in a screen replacement position;

FIG. 2 shows the aspect of the filtering device according to the disclosure in a cross-sectional view transverse to a longitudinal axis of the screen carrier;

FIGS. 3 and 4 show the aspect of the filtering device according to the disclosure in a first venting position;

FIGS. 5 and 6 show the aspect of the filtering device according to the disclosure in a second venting position;

FIGS. 7 and 8 show the aspect of the filtering device according to the disclosure in a third venting position;

FIGS. 9 and 10 show the aspect of the filtering device according to the disclosure in an acceleration position area;

FIGS. 11 and 12 show the aspect of the filtering device according to the disclosure in a filtering position;

FIGS. 13, 14, and 15 show different views of a second aspect of a filtering device according to the disclosure in a filtering position;

FIGS. 16 and 17 show the second aspect of the screen carrier according to the disclosure in different operating positions on the way to a backflushing position; and

FIGS. 18 and 19 show the second aspect of the screen carrier according to the disclosure in a backflushing position.

### DETAILED DESCRIPTION

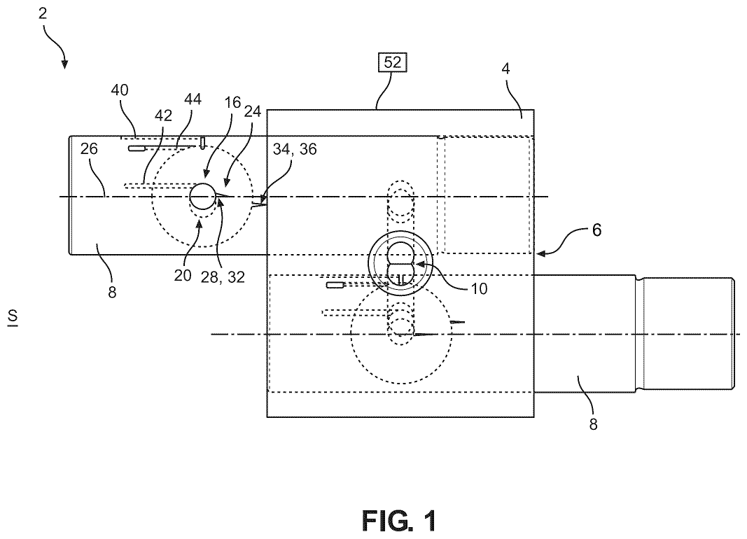

FIG. 1 shows a filtering device 2 for filtering a fluid. The fluid is a liquefied plastic, in particular. Filtering device 2 includes a housing 4. Housing 4 has a receptacle 6 for receiving a screen carrier 8. Housing 4 also has a fluid inlet channel 10 and a fluid outlet channel 12. A screen carrier 8 is received in receptacle 6. In the following description, reference is made only to the screen carrier 8 arranged at the top. However, the comments apply analogously to the lower screen carrier 8. Each of the screen carriers 8 is accommodated movably along longitudinal axis 26 inside receptacle 6. Screen carrier 8 has a screen carrier inlet 16, a screen carrier outlet 18 and a cavity 20 for receiving filter element 22. Cavity 20 is in fluid communication with screen carrier inlet 16 and screen carrier outlet 18.

In FIG. 1, the upper screen carrier 8 is shown in a screen replacement position S. In this screen replacement position S, the filter element 22 can be replaced. Screen carrier 8 can basically be moved from the screen replacement position S shown in FIG. 1 into a filtering position F via a venting position area E. Screen carrier tank 8 has a throttle recess 24. Throttle recess 24 is arranged adjacent to screen carrier outlet 18 and is in fluid communication with cavity 20. Throttle recess 24 extends along longitudinal axis 26, starting from screen carrier outlet 18 and, viewed from screen replacement position S, in the direction of fluid outlet channel 12. Throttle recess 24 has a cross-section 28 that varies in the direction of longitudinal axis 26. The cross-section 28 of throttle recess 24 tapers, in particular linearly, in the direction of longitudinal axis 26, starting from screen carrier outlet 18. Cross-section 28 has a basic form 32 that is wedge-shaped. Screen carrier 8 also has an inlet throttle recess 34 next to screen carrier inlet 16.

Inlet throttle recess 34 is likewise in fluid communication with cavity 20. Inlet throttle recess 34 extends along longitudinal axis 26, starting from screen carrier inlet 16 and, viewed from screen replacement position S shown in FIG. 1, in the direction of fluid inlet channel 10. Inlet throttle recess 34 has a cross-section 36 that varies in the direction of longitudinal axis 26. Screen carrier 8 also has a first venting recess 40, a second venting recess 42 and a third venting recess 44. Venting recesses 40, 42, 44 put cavity 20 in fluid communication with the surroundings, depending on the positions of venting recesses 40, 42, 44 relative to housing 4.

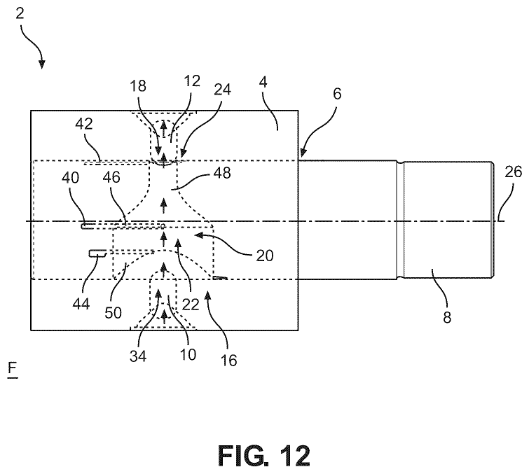

Venting recesses 40, 42, 44 extend along longitudinal axis 26. When screen carrier 8 moves from the screen replacement position S shown in FIG. 1 in the direction of filtering position F shown in FIG. 12, cavity 20 is firstly vented via all three venting recesses 40, 42, 44, then vented on further movement of screen carrier 8 in the direction of filtering position F via the first and second venting recesses 40, 42 and then exclusively via the first venting recess 40 when screen carrier 8 advances further. The second venting recess 42 has a smaller longitudinal extension along longitudinal axis 26 than the first venting recess 40. The third venting recess 44 has a smaller longitudinal extension along the longitudinal axis 26 than the second venting recess 42. Venting recesses 40, 42, 44 are designed as grooves.

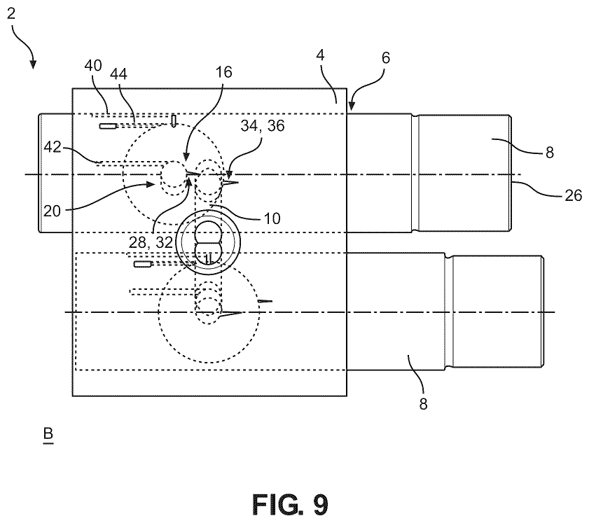

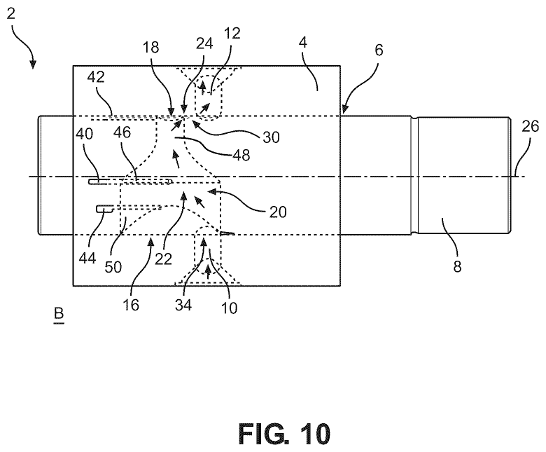

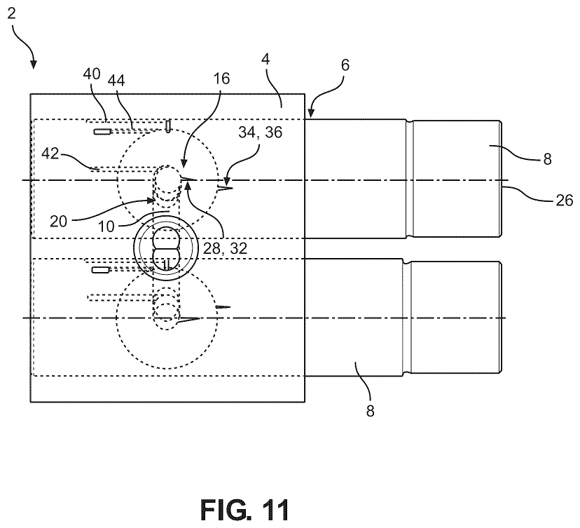

Filtering device 2 also has a control unit 52. Control unit 52 is configured and designed in such a way that, after venting of cavity 20 within an acceleration position area B (cf. FIGS. 9 and 10), it moves screen carrier 8 further by means of control signals in the direction of filtering position F, such that fluid outlet channel 12 is initially in exclusive fluid communication with throttle recess 24 with cavity 20, and screen carrier 8 is moved in the direction of filtering position F in such a way a fluid pressure in fluid inlet channel 10 and/or in fluid outlet channel 12 stays within a definable pressure range.

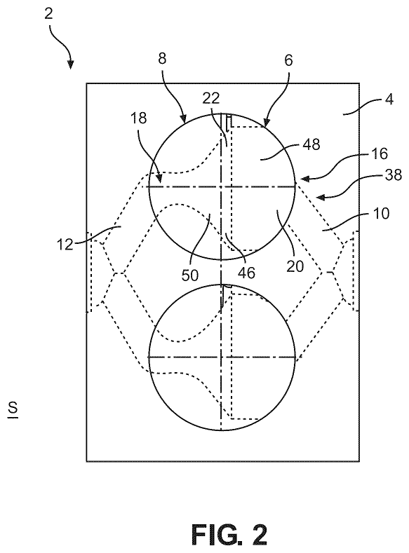

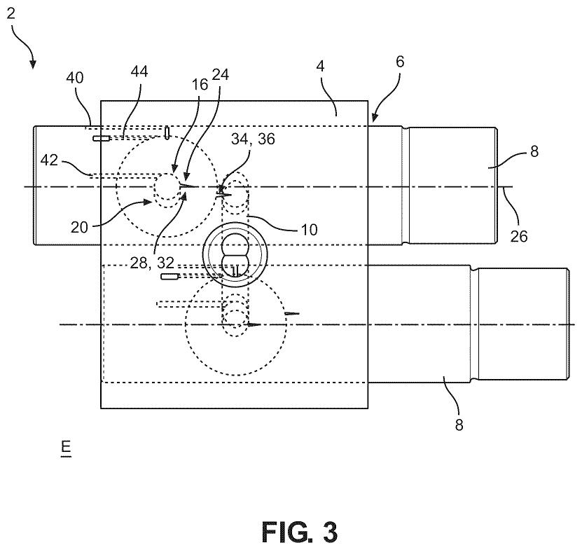

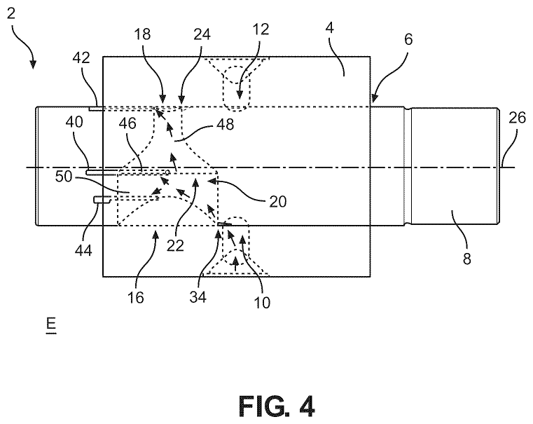

FIG. 2 shows a side view of filtering device 2 in the operating condition according to FIG. 1. FIGS. 3 and 4 show filtering device 2 in a first venting position. In this position, inlet throttle recess 34 overlaps fluid inlet channel 10 at least partially. In other words, fluid communication is established between fluid inlet channel 10 and cavity 20 via inlet throttle recess 34 (indicated in FIG. 4 by flow arrows in the region of fluid inlet channel 10), so that melt can flow from fluid inlet channel 10 into cavity 20, namely in a very finely dosable manner. Depending on the position of inlet throttle recess 34 relative to fluid inlet channel 10, a variable flow cross-section 38 is opened between cavity 20 and fluid inlet channel 10.

In other words, cavity 20 is in exclusive fluid communication with fluid inlet channel 10 during venting. Venting recesses 40, 42, 44 are connected to the surroundings of filtering device 2, so air can flow out of cavity 20 when melt flows into cavity 20. As can be seen from FIG. 4, which relates to the same operating condition, venting recess 40 is in fluid communication with a first subarea 46 of cavity 20. Venting recess 40 has a tap hole. The second venting recess 42 is in fluid communication with a second subarea 48 of cavity 20. The third venting recess 44 is in fluid communication with a third subarea 50 of cavity 20.

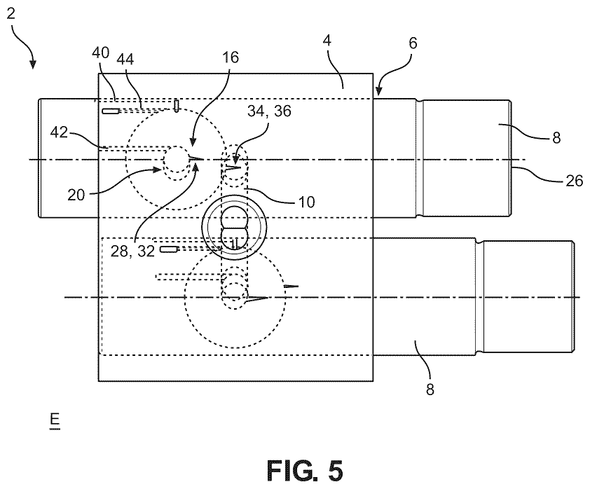

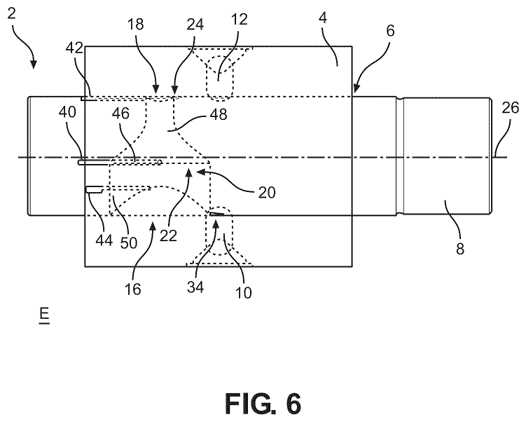

In the operating condition shown in FIGS. 5 and 6, there is now a direct connection between fluid inlet channel 10 and cavity 20 due to a respective overlap with screen carrier inlet 16. In the position shown in FIGS. 5 and 6, only the first venting recess 40 and the second venting recess 42 are connected to the atmosphere. This means that melt is pressed into the subareas of cavity 20 that are connected to the venting recesses.

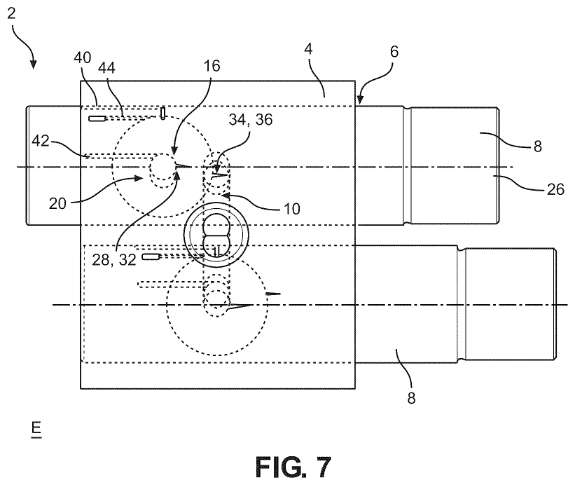

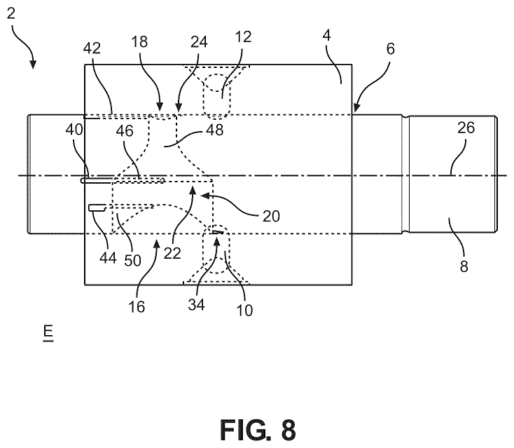

FIGS. 7 and 8 show another venting step in which only the first venting recess 40 is connected to the surroundings, with the result that the particular subarea 46 of cavity 20 is vented that is arranged adjacent to filter element 22. In acceleration position area B shown in FIGS. 9 and 10, cavity 20 is completely vented, and there is fluid communication with fluid inlet channel 10 (indicated by flow arrows in FIG. 10). Venting recesses 40, 42, 44 are no longer connected to the surroundings of filtering device 2. In the condition shown in FIGS. 9 and 10, throttle recess 24 now comes into contact with fluid outlet channel 12. Depending on the position of throttle recess 24 relative to fluid outlet channel 12, a variable flow cross-section 30 is selectively and finely adjustably opened as a result between cavity 20 and fluid outlet channel 12. Due to cavity 20 being connected to fluid outlet channel 12 via throttle recess 24, a stream of melt is set in motion from cavity 20 in the direction of fluid outlet channel 12, namely in such a gentle manner that the effects on the overall system pressure are kept within narrow limits. After the acceleration operation, screen carrier 8 is pushed further to the right in the direction of filtering position F. In filtering position F, cavity 20 is fully connected to both fluid inlet channel 10 and fluid outlet channel 12, and filtering device 2 filters fluid passing through by means of filter element 22. If filter element 22 needs to be replaced, screen carrier 8 is advanced into the position shown in FIG. 1 and the process starts from the beginning again.

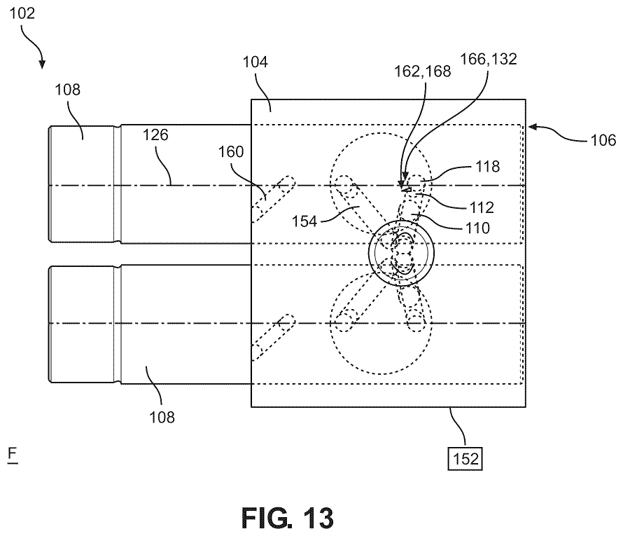

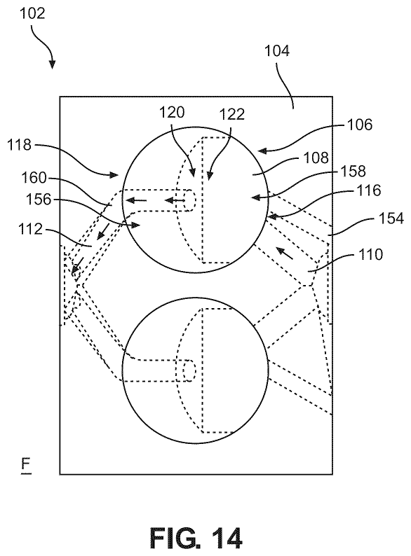

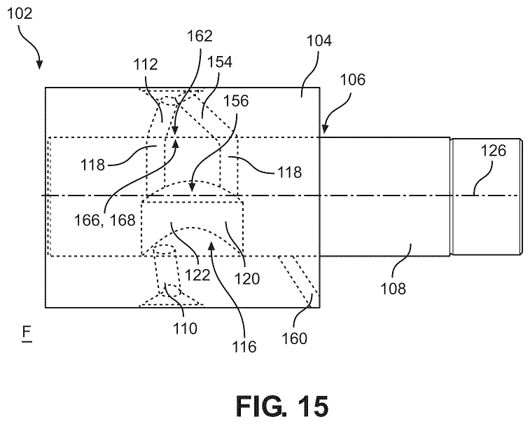

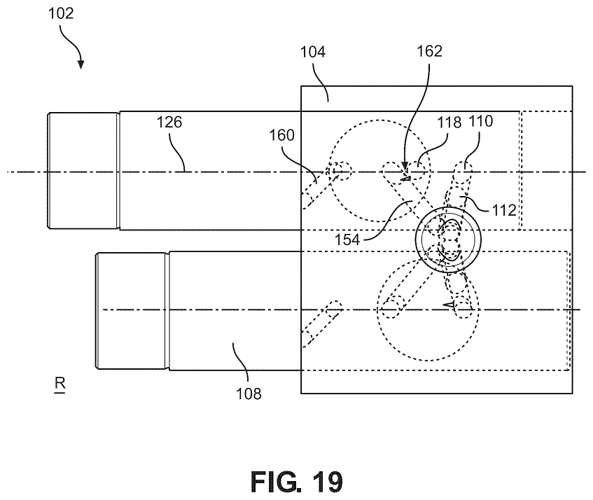

FIGS. 13 to 19 show an alternative aspect of a filtering device 102. Filtering device 102 has a housing 104 with a receptacle 106 for accommodating a screen carrier 108. Housing 104 also has a fluid inlet channel 110 and a fluid outlet channel 112. Inside receptacle 106, a screen carrier 108 received movably therein along a longitudinal axis 126 and having a screen carrier inlet 116 and a screen carrier outlet 118 (see FIG. 14) is movably accommodated. Screen carrier 108 also has a cavity 120 for receiving a filter element 122. As can be seen from FIG. 14 in particular, cavity 120 is in fluid communication with screen carrier inlet 116 and screen carrier outlet 118. In the condition shown in FIGS. 13 and 14, screen carrier 108 is in a filtering position F, in which fluid to be filtered flows via fluid inlet channel 110 into cavity 120, filtered therein by filter element 122, then leaves cavity 120 via fluid outlet channel 112.

Housing 104 also has a backflush supply channel 154. Backflush supply channel 154 is configured to feed backflush fluid to filter element 122 in a backflush position area R, from the clean side 156 of filter element 122 to dirt side 158. Housing 104 also has a backflush channel 160. Backflush channel 160 is configured to discharge the backflush fluid after backflushing. Screen carrier 108 can be moved within a backflush position area, in which backflush supply channel 154 is at least partially in fluid communication with the clean side 156 of filter element 122. Screen carrier 108 also has a backflush recess or throttle recess 24. Backflush recess 162 is arranged between backflush supply channel 154 and screen carrier outlet 118 and is in fluid communication with cavity 120. Backflush recess 162 extends along longitudinal axis 126, starting from screen carrier outlet 118 and, viewed from filtering position F, in the direction of backflush supply channel 154. Backflush recess 162 has a cross-section 166 that varies in the direction of longitudinal axis 126. The cross-section 166 of backflush recess 162 tapers, in particular linearly, in the direction of the longitudinal axis 126, starting from screen carrier outlet 118. Cross-section 166 has a basic form 132 that is wedge-shaped.

Filtering device 102 also has a control unit 152. Control unit 152 is configured and designed so that it changes the position of screen carrier 108 during backflushing of screen carrier 108 by means of control signals in such a way that the fluid pressure in fluid inlet channel 110 and/or in fluid outlet channel 112 stays within a definable pressure range during backflushing, such that a variable flow cross-section 164 is opened between backflush supply channel 154 and cavity 120 by means of backflush recess 162 when screen carrier 108 is moved into backflush position area R.

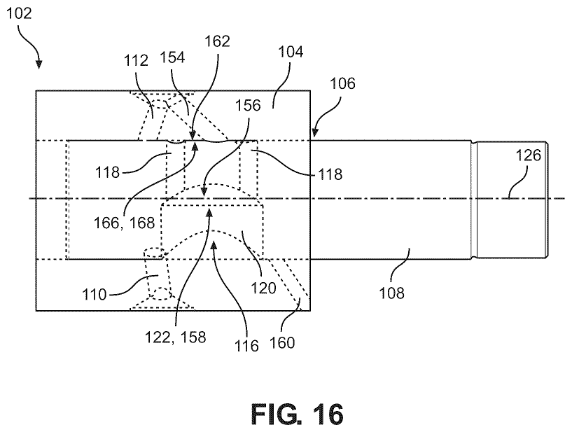

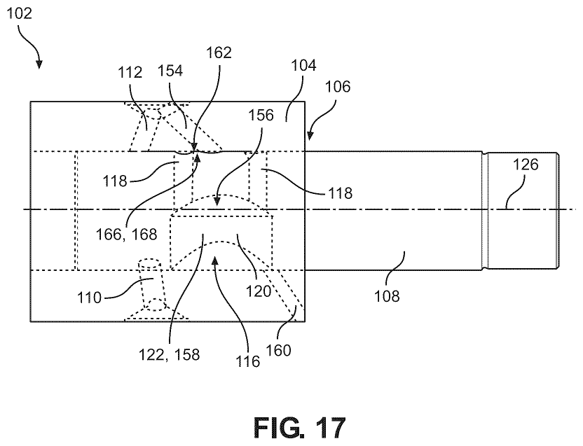

In the condition shown in FIGS. 13 to 15, filtering device 102 is in filtering position F, as noted above. Fluid or melt is fed via fluid inlet channel 110, enters cavity 120, is filtered there by means of filter element 122 and finally leaves housing 104 via fluid outlet channel 112 and backflush supply channel/fluid outlet channel 154 (indicated by flow arrows in FIG. 14). In the condition shown in FIG. 16, screen carrier 108 has been moved to the right, as viewed in the plane of the drawing, in such a way that a connection of cavity 120 to fluid outlet channel 112 is initially interrupted. If, as shown in FIG. 17, screen carrier 108 is now moved further to the right in the plane of the drawing, it is also disconnected from fluid inlet channel 110. At the same time, however, cavity 120 is connected to backflush channel 160.

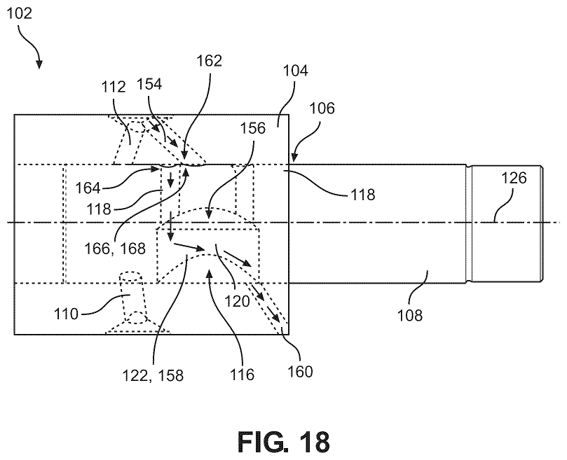

In the condition shown in FIG. 18, screen carrier 108 has now been moved even further to the right, in such a way that backflush recess 162 comes into contact with backflush supply channel 154. Starting from the backflush supply channel 154, backflush fluid, in particular plastic melt that has already been filtered, thus enters cavity 120 (in the direction of the flow arrows), in particular the clean side 156 of the filter element 122, via backflush recess 162. From there, the backflush fluid passes through filter element 122 in the opposite direction to the filtering direction, cleans it in the process, before the contaminated backflush fluid is finally ejected via backflush channel 160. By means of backflush recess 162, a variable flow cross-section 164 between backflush supply channel 154 and cavity 120 can be very finely adjusted, so that the effects on the overall system pressure during backflushing stays within narrowly definable limits.

Further to the above descriptions of a method for operating a filtering device, the manner of operation and steps of a method are described below with reference to the described Figures.

The method for operating filtering device 2 comprises the steps of:
venting cavity 20,
moving screen carrier 8 further in the direction of filtering position F by means of control signals after venting cavity 20, in such a way that fluid outlet channel 12 is initially put into exclusive fluid communication with cavity 20 by means of throttle recess 24, and screen carrier 8 is moved in the direction of filtering position F in such a way that a fluid pressure in fluid inlet channel 10 and/or in fluid outlet channel 12 stays within a definable pressure range.

The method may also proceed as follows:
moving screen carrier 108 in the direction of backflush position area R by means of control signals provided by control unit 52, in such a way that the fluid pressure in fluid inlet channel 110 and/or in fluid outlet channel 112 stays within a definable pressure range during backflushing, wherein, when screen carrier 108 moves in the direction of backflush position area R, a variable flow cross-section 164 between backflush supply channel 154 and cavity 120 is opened by means of backflush recess 162, wherein backflush recess 162 is arranged between backflush supply channel 154 and screen carrier outlet 118 and is in fluid communication with the cavity 120.

### LIST OF REFERENCE SIGNS

2 Filtering device
4 Housing
6 Receptacle
8 Screen carrier
10 Fluid inlet channel
12 Fluid outlet channel
16 Screen carrier inlet
18 Screen carrier outlet
20 Cavity
22 Filter element
24 Throttle recess
26 Longitudinal axis
28 Cross-section of the throttle recess
30 Variable flow cross-section at the throttle recess
32 Wedge-shaped basic form
34 Inlet throttle recess
36 Cross-section of the inlet throttle recess
38 Variable flow cross-section at the inlet throttle recess
40 (First) venting recess
42 Second venting recess
44 Third venting recess
46 First subarea of the cavity
48 Second subarea of the cavity
50 Third subarea of the cavity
52 Control unit
102 Filtering device
104 Housing
106 Receptacle
108 Screen carrier
110 Fluid inlet channel
112 Fluid outlet channel
116 Screen carrier inlet
118 Screen carrier outlet
120 Cavity
122 Filter element
126 Longitudinal axis
152 Control unit
154 Backflush supply channel/fluid outlet channel
156 Clean side of the filter element
158 Dirt side of the filter element
160 Backflush channel
162 Backflush recess
164 Variable flow cross-section at the backflush recess
166 Cross-section of the backflush recess
168 Wedge-shaped basic form
B Acceleration position area
S Screen replacement position
E Venting position area
F Filtering position
R Backflush position area

1.-22. (canceled)

23. A filtering device for filtering a fluid, in particular a liquefied plastic, comprising:
a housing having a receptacle for receiving a screen carrier, and having a fluid inlet channel and a fluid outlet channel; and
a screen carrier movably received along a longitudinal axis inside the receptacle and having a screen carrier inlet, a screen carrier outlet and a cavity for receiving a filter element, wherein the cavity is in fluid communication with the screen carrier inlet and the screen carrier outlet,
wherein the screen carrier can be moved from a screen replacement position via a venting position area into a filtering position, and
wherein the screen carrier has a throttle recess which is arranged adjacent to the screen carrier outlet and which is in fluid communication with the cavity, and which opens a variable flow cross-section between the cavity and the fluid outlet channel, depending on a position of the throttle recess relative to the fluid outlet channel.

24. The filtering device according to claim 23, wherein the screen carrier can be moved out of the venting position area via an acceleration position area into the filtering position, and wherein the throttle recess opens a variable flow cross-section between the cavity and the fluid outlet channel, depending on a position of the throttle recess relative to the fluid outlet channel in the acceleration position area.

25. The filtering device according to claim 23, wherein the throttle recess extends along the longitudinal axis, starting from the screen carrier outlet and viewed from the screen replacement position in a direction of the fluid outlet channel.

26. The filtering device according to claim 23, wherein the throttle recess has a cross-section that varies in a direction of the longitudinal axis.

27. The filtering device according to claim 26, wherein the cross-section of the throttle recess tapers in a direction of the longitudinal axis, starting from the screen carrier outlet.

28. The filtering device according to claim 26, wherein the cross-section of the throttle recess tapers linearly in the direction of the longitudinal axis, starting from the screen carrier outlet.

29. The filtering device claim 26, wherein the cross-section has a basic form that is wedge-shaped or notch-shaped.

30. The filtering device according to claim 24, wherein the fluid inlet channel and the fluid outlet channel are arranged in the housing in such a way that when the screen carrier moves from the screen replacement position via the venting position area and the acceleration position area in a direction of the filtering position, the cavity in the venting position area is initially, in particular exclusively, in fluid communication with the fluid inlet channel and when the screen carrier moves further in the direction of the filtering position, the cavity in the acceleration position area is additionally put in fluid communication with the fluid outlet channel via the throttle recess.

31. The filtering device according to claim 27, wherein the screen carrier adjacent to the screen carrier inlet has an inlet throttle recess which is in fluid communication with the cavity, and which opens a variable flow cross-section between the cavity and the fluid inlet channel, depending on a position of the inlet throttle recess relative to the fluid inlet channel in the venting position area.

32. The filtering device according to claim 31, wherein the inlet throttle recess extends along the longitudinal axis starting from the screen carrier inlet and viewed from the screen replacement position in the direction of the fluid inlet channel, and/or wherein the inlet throttle recess has a cross-section that varies in the direction of the longitudinal axis.

33. The filtering device claim 31, wherein the cavity in the venting position area is exclusively in fluid communication with the fluid inlet channel.

34. The filtering device according to claim 24, further comprising a control unit, which is configured and designed in such a way that after venting of the cavity it moves the screen carrier further by means of control signals via the acceleration position area in a direction of the filtering position such that the fluid outlet channel is initially put into exclusive fluid communication with the cavity by means of the throttle recess, and the screen carrier is moved in the direction of the filtering position in such a way that a fluid pressure in the fluid inlet channel and/or in the fluid outlet channel stays within a definable pressure range.

35. The filtering device according to claim 23,
wherein the screen carrier is vented in the venting position area by feeding a fluid via the fluid outlet channel, and
wherein the screen carrier has a throttle recess which is arranged adjacent to the screen carrier inlet and which is in fluid communication with the cavity, and which opens a variable flow cross-section between the cavity and the fluid inlet channel, depending on the position of the throttle recess relative to the fluid inlet channel.

36. The filtering device according to claim 23,
wherein the housing has a backflush supply channel which is configured to feed backflush fluid to the filter element in a backflush position area from a clean side of the filter element to a dirt side, and a backflush channel which is configured to discharge the backflush fluid after backflushing,
wherein the screen carrier can be moved into a backflush position area in which the backflush supply channel is at least partially in fluid communication with the clean side of the filter element, and the backflush channel is at least partially in fluid communication with the dirt side of the filter element, and
wherein the screen carrier has a backflush recess which is arranged between the backflush supply channel and the screen carrier outlet and is in fluid communication with the cavity, and which opens a variable flow cross-section between the backflush supply channel and the cavity, depending on a position of the backflush recess relative to the backflush supply channel in the backflush position area.

37. The filtering device according to claim 36, wherein the backflush recess extends along the longitudinal axis, starting from the screen carrier outlet and viewed from the filtering position in a direction of the backflush supply channel.

38. The filtering device claim 36, wherein the backflush recess has a cross-section that varies in a direction of the longitudinal axis.

39. The filtering device claim 36, wherein a cross-section of the backflush recess tapers in a direction of the longitudinal axis, starting from the screen carrier outlet.

40. The filtering device claim 36, wherein a cross-section of the backflush recess tapers linearly in a direction of the longitudinal axis, starting from the screen carrier outlet.

41. The filtering device claim 36, wherein a cross-section has a basic form that is wedge-shaped or notch-shaped.

42. The filtering device claim 36, further comprising a control unit, which is configured and designed so that it changes a position of the screen carrier during backflushing of the screen carrier by means of control signals in such a way that a fluid pressure in the fluid inlet channel and/or in the fluid outlet channel stays within a definable pressure range during backflushing, such that a variable flow cross-section between the backflush supply channel and the cavity is opened by means of the backflush recess when the screen carrier is moved within the backflush position area.

43. A method for backflushing the filtering device according to claim 23 comprising:
venting the cavity, and
moving the screen carrier further in a direction of the filtering position by means of control signals after venting the cavity, in such a way that the fluid outlet channel is initially put into exclusive fluid communication with the cavity by means of the throttle recess, and the screen carrier is moved in the direction of the filtering position in such a way that a fluid pressure in the fluid inlet channel and/or in the fluid outlet channel stays within a definable pressure range.

44. A method for backflushing the filtering device of claim 36, comprising:
moving the screen carrier in a direction of the backflush position area by means of control signals in such a way that a fluid pressure in the fluid inlet channel and/or in the fluid outlet channel stays within a definable pressure range, during backflushing,
wherein a variable flow cross-section between the backflush supply channel and the cavity is opened by means of the backflush recess, wherein the backflush recess is arranged between the backflush supply channel and the screen carrier outlet and is in fluid communication with the cavity.
